(19) United States
(12) Patent Application Publication
(10) Pub. No.: US 2013/0160211 A1
(43) Pub. Date: Jun. 27, 2013

(54) PELVIC EXAMINATION WEDGE

(71) Applicants: Michael A. Klein, Eatontown, NJ (US); Eric S. Klein, New York, NY (US)

(72) Inventors: Michael A. Klein, Eatontown, NJ (US); Eric S. Klein, New York, NY (US)

(73) Assignee: TSK Products LLC, Eatontown, NJ (US)

(21) Appl. No.: 13/525,718

(22) Filed: Jun. 18, 2012

Related U.S. Application Data
(60) Provisional application No. 61/499,530, filed on Jun. 21, 2011.

(51) Int. Cl. A61G 13/12

(52) U.S. Cl. CPC A61G 13/123
USPC 5/648

(57) ABSTRACT

A pelvic examination wedge made of medical grade foam with a medical grade vinyl cover. The pelvic exam wedge includes a sloping top surface portion that slopes backwards from a front vertical face along sloping edge walls toward a bottom portion. The bottom portion lies flat on a surface, such as an examination table or gurney. The front vertical face connects the bottom portion and the sloped top portion. A semi-circular cut-out extends from the front vertical face parallel to the sloping edge walls to form a cavity in the pelvic exam wedge that is sufficiently deep and wide to allow the unencumbered use of instruments during examination of the patient.

### CROSS REFERENCE TO RELATED APPLICATIONS

This application claims priority under 35 U.S.C. §119(e) from provisional application No. 61/499,530 filed Jun. 21, 2011. The 61/499,530 provisional application is incorporated by reference herein, in its entirety, for all purposes.

### BACKGROUND

Gynecological examinations of female patients may be performed using specialized equipment, such as a table that provides means for supporting the pelvis of the female patient in a elevated and inclined position. However, it is often the case that a pelvic exam may be required to be performed in a location that is not equipped with a specialized table. For example, an emergency facility is not likely to have a table that is particularly suited for gynecological exams.

Foam wedges have been used in a hospital setting as position aids in surgery and rehabilitation. While a generic wedge-shaped device may be suitable for many applications, the particular requirements of pelvic examinations make such generic devices unsuitable or difficult to use. In particular, such devices typically encumber the use of specula and other instruments used to perform the pelvic examination and other gynecological procedures and do not provide for collection of bodily fluids.

### SUMMARY

Embodiments are directed to a positioning aid in the form of a pelvic exam wedge. The pelvic exam wedge may be configured with a cut-out to provide room to maneuver a speculum or other instruments.

### DESCRIPTION OF THE DRAWINGS

FIG. 1 is a block diagram that illustrates a first view of a pelvic exam wedge according to an embodiment.

FIG. 2 is a block diagram that illustrates a second view of a pelvic exam wedge according to an embodiment.

### DETAILED DESCRIPTION

Embodiments are directed to a positioning aid in the form of a pelvic exam wedge. The pelvic exam wedge may be configured with a cut-out to provide room to maneuver a speculum or other instruments. The cut-out further facilitates the positioning of an emesis basin for controlled capture of fluids (urine, blood, semen) that may be discharged during a pelvic examination.

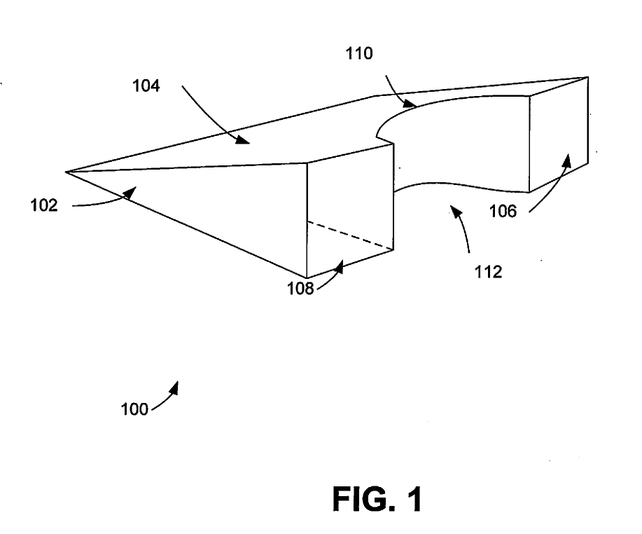

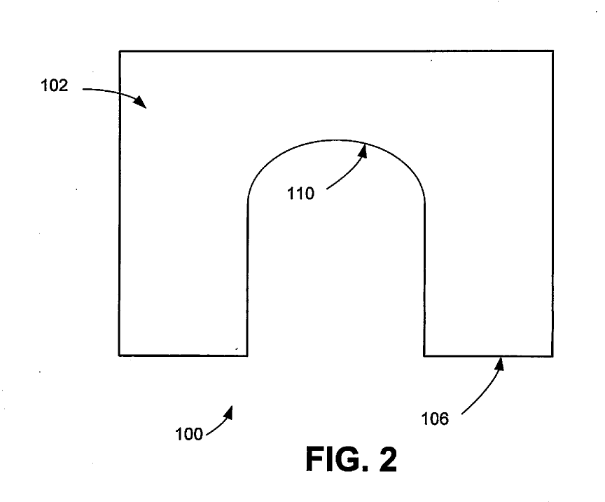

FIG. 1 is a block diagram that illustrates a first view of a pelvic exam wedge according to an embodiment. FIG. 2 is a block diagram that illustrates a second view of a pelvic exam wedge according to an embodiment. The description that follows refers to FIG. 1 and FIG. 2

In one embodiment, a pelvic exam wedge 100 is made of medical grade foam with a medical grade vinyl cover 102. The vinyl cover may be flame retardant, anti-microbial, anti-static, tear resistant and stain resistant. The vinyl cover is configured to be cleaned with standard disinfectant products. In an alternative embodiment, the vinyl cover may be removable for cleaning. In still another embodiment, the vinyl cover is replaced with a disposable cover that is sized and dimensioned to fit the contours of the pelvic wedge.

The pelvic exam wedge includes a sloping top surface portion 104 that slopes backwards from a front vertical face 106 along sloping edge walls toward a bottom portion 108. The bottom portion 108 lies flat on a surface, such as an examination table or gurney (not illustrated). The front vertical face 106 connects the bottom portion 108 and the sloped top portion 104. A semi-circular cut-out 110 extends from the front vertical face 106 parallel to the sloping edge walls to form a cavity 112 in the pelvic exam wedge 100. The semi-circular cut-out 110 is centered on the width of the front vertical face 106.

In an embodiment, the pelvic exam wedge is approximately 18 inches wide and 18 inches long. The front vertical face is approximately 6 inches high, such as 5.5-7.5 inches high. The semi-circular cutout has a radius of about 4 inches, such as 4 inches to 5 inches. The radius of semi-circular cut-out relative to the width of the front vertical face is such that the sides of the cut-out are sufficiently wide to support the thighs of the patient when properly oriented on the pelvic examination wedge and the cut-out is sufficiently deep and wide to allow the unencumbered use of instruments during examination of the patient. Additionally, cut-out may accommodate the curve and shape of the emesis basin thereby allowing the controlled capture of fluids (urine, blood, semen) that may be discharged during a pelvic examination.

The foregoing descriptions are provided merely as illustrative examples and are not intended to require or imply that the blocks of the various embodiments must be performed in the order presented. Words such as “thereafter,” “then,” “next,” etc. are not intended to limit the order of the blocks; these words are simply used to guide the reader through the description of the methods. Further, any reference to claim elements in the singular, for example, using the articles “a,” “an,” or “the,” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the following claims and the principles and novel features disclosed herein.

What is claimed is:

1. A pelvic examination wedge for facilitating a pelvic examination of a female patient comprising:
a compressible rigid body having a wedge shape and comprising:
a top surface portion;
a bottom surface portion;
a front vertical face, and
two parallel sloping edge walls,
wherein the top surface slopes backwards from a top edge of the front vertical face along the top edges of the parallel sloping edge walls to a back edge of the bottom portion,
wherein the bottom portion connects a bottom edge of the front vertical wall and bottom edges of the parallel edge walls, and
wherein a semi-circular cavity is formed in the rigid body that extends from the front vertical face through the bottom portion and the sloped top portion.

2. The pelvic examination wedge of claim 1, wherein the length and the width of the wedge are each approximately 18 inches, the height of the front vertical face is about 6 inches and the radius of the semi-circular cavity is about 4 inches.
